(19) United States
(12) Patent Application Publication
(10) Pub. No.: US 2011/0125777 A1
(43) Pub. Date: May 26, 2011

(54) Sense and Match Advertising Content

(75) Inventors: Lee Begeja, Gillette, NJ (US); Zhu Liu, Marlboro, NJ (US); Bernard S. Renger, New Providence, NJ (US); Behzad Shahraray, Holmdel, NJ (US)

(73) Assignee: AT&T INTELLECTUAL PROPERTY I, L.P., Reno, NV (US)

(21) Appl. No.: 12/625,905

(22) Filed: Nov. 25, 2009

(51) Int. Cl. G06F 7/10; G06F 17/30; G06F 15/16

(52) U.S. Cl. 707/769; 707/E17.108; 709/231

(57) ABSTRACT

The present disclosure generally provides a method for delivering targeted content to a user device based on environmental variables sensed at or near the user device. At least one sensed environmental variable associated with a user device is received. At least one environmental state is determined based on the at least one environmental variable. Content is then selected to be delivered to the user device based on the at least one environmental state, and the selected content is delivered to the user device.

### BACKGROUND

The present disclosure relates generally to delivering content to a mobile device and more specifically to delivering content to a mobile device based on sensed environmental variables.

As recent technological developments for mobile devices, such as cell phones, personal digital assistants, etc., have occurred, content available for such mobile devices has dramatically increased. For example, streaming services including streaming music, video, and games are available to mobile users, as well as network services, such as Internet access, email, text messaging, etc. The increase in the services and content available to mobile users has also led to an increase in advertising opportunities for service providers. However, advertising content is not always relevant to all users who receive such content. One way in which service providers have attempted to target advertising is through the use of location-based advertising. Location-based advertising typically uses the current location of a mobile device (e.g., GPS location) to target advertisements to the mobile device that are relevant to that location. For example, advertisements for stores, restaurants, or activities near the current location of a mobile device can be sent to that mobile device.

### BRIEF SUMMARY

The present disclosure generally provides methods for delivering targeted content to a user device based on environmental variables sensed at or near the user device. Embodiments of the present disclosure match content, such as advertising content, to a variety of environmental states based on sensed environmental variables, such as sound, temperature, humidity, etc., in order to target content that is applicable for a user's current environment.

In a first embodiment, at least one sensed environmental variable associated with a user device is received. At least one environmental state is determined based on the at least one environmental variable. Content is then selected to be delivered to the user device based on the at least one environmental state, and the selected content is delivered to the user device.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary system configured to implement an embodiment of the present disclosure;

FIG. 2 illustrates an exemplary user device configured to implement another embodiment of the present disclosure;

FIG. 3 illustrates an exemplary system configured to implement another embodiment of the present disclosure;

FIG. 4 illustrates a method for targeted content delivery according to an embodiment of the present disclosure; and

FIG. 5 illustrates a high level block diagram of a computer capable of implementing the present disclosure.

### DETAILED DESCRIPTION

The present disclosure generally provides methods for delivering targeted content to a mobile device based on environmental variables sensed at the mobile device. Embodiments of the present disclosure match content, to be delivered to a user device, to a variety of environmental states based on sensed environmental variables associated with the user device. As defined herein, an environmental variable is a measured condition, other than location, of the environment at or in the vicinity of a user device, and an environmental state is a current state of the environment at or in the vicinity of the user device deduced from one or more environmental variables.

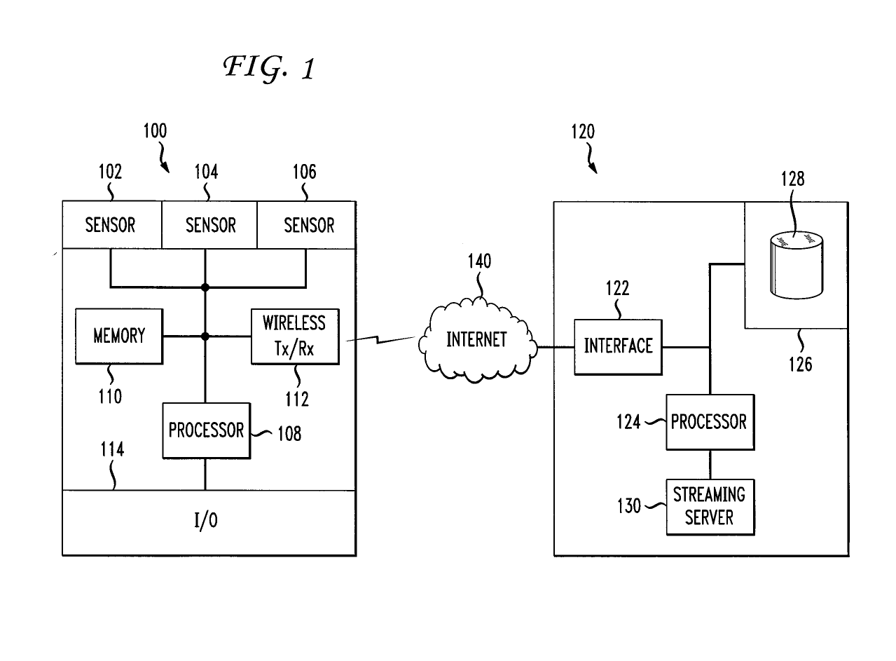

FIG. 1 illustrates an exemplary system configured to implement an embodiment of the present disclosure. As illustrated in FIG. 1, the system includes a user device 100. The user device 100 can be a mobile device, such as a cell phone, personal digital assistant, lap top computer, etc. The user device 100 includes sensors 102, 104, and 106 that sense various environmental variables at the user device 100. According to an advantageous implementation, the sensors 102, 104, and 106 may include one or more of a noise or volume sensor, a temperature sensor, a humidity sensor, an atmospheric pressure sensor, a smell sensor, and/or any other sensors that can measure a current condition at the user device 100.

The user device 100 includes a processor 108, memory 110, wireless transceiver 112, and input/output 114. The processor 108 controls operation of the sensors 102, 104, and 106, the memory 110, the wireless transceiver 112, and the input/output 114. The environmental variables sensed by the sensors 102, 104, and 106 can be stored in the memory 110. Via the wireless transceiver 112, the user device 100 can communicate with other devices, service providers, the Internet 140, etc. The input/output 114 allows for user interaction with the user device 100. For example, the input/output 114 can include, but is not limited to, a display, touch screen, keyboard, mouse, speakers, buttons, etc.

The environmental variables sensed by the sensors 102, 104, and 106 are transmitted to a server 120. For example, the wireless transceiver 112 of the user device 102 can connect to the Internet 140 (e.g., via an Access Point) and transmit the environmental variables to the server over the Internet 140. The server 120 includes an interface 122, processor 124, memory 126, and streaming server 130. The processor controls operation of the interface 122, memory 126, and streaming server 130. The interface 122 connects the server 120 to the Internet 140. The interface 122 of the server 120 receives the environmental variables transmitted via the Internet 140 by the wireless transceiver 110 of the user device 100. The streaming server 130 provides streaming content, such as streaming video or streaming music, to user devices. As illustrated in FIG. 1, the streaming server 130 is part of server 120 and uses the interface 122 to transmit the streaming content via the Internet 140. However, it is possible that the streaming server be implemented as a separate server from server 120.

A content database 128 is stored in the memory 126 of the server 120. The content database stores content that is associated with various environmental states. According to one embodiment, the content database stores advertising content that is associated with various environmental states, but the present disclosure is not limited thereto. The content database 128 is shown in FIG. 1 as being stored in the memory 126 of the server 120. However, it is also possible that the content database can be stored remotely from server 120. When the environmental variables are received from the user device 100, the processor 124 deduces at least one environmental state based on the environmental variables and selects content in the content database 128 to match the deduced environmental state. The selected content that matches the current environmental state(s) of the user device 100 is then added to the content being streamed by the streaming server 130 to the user device 100. For example, if the content is advertising content, the streaming server can stream advertisements selected to match the current environmental state at the user device 100, in addition to the streaming video or music being streamed to the user device 100. The content selected to match the current environmental state at the user device 100 is received by the wireless transceiver 112 and output to the user via input/output 114. For example, the content can be displayed on a display and/or played through speakers of the user device 100.

In response to the content output by the user device 100, user feedback may be transmitted to the server 120. For example, a user may enter feedback to the selected content via input/output 114, or user feedback may be automatically sensed by one or more sensors 102, 204, and 106. The user feedback may then be transmitted from the user device 100 to the server 120. The server 120 can then use the user feedback in addition to the current sensed environmental variables to select additional content to deliver to the user device 102. This can be used to improve the selection of environment dependent content for a particular user.

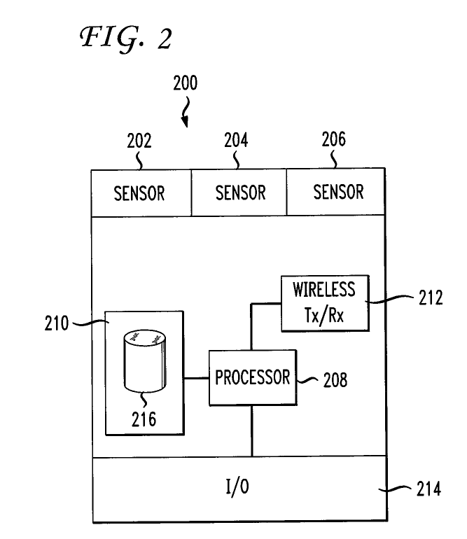

As illustrated in FIG. 1, the sensed environmental variables are received at the server 120 from the user device 100, and the server selects and delivers content based on the sensed environmental variables. The server could alternatively be on the device, as could the ad content. This could all have been stored locally on whatever device the user is viewing. FIG. 2 illustrates an exemplary user device 200 configured to implement another embodiment of the present disclosure, in which the user device 200 selects stored content based on the sensed environmental variables. As illustrated in FIG. 2, the user device 200 includes sensors 202, 204, and 206 that sense various environmental variables at the user device 200. According to an advantageous implementation, the sensors 202, 204, and 206 may include one or more of a noise or volume sensor, a temperature sensor, a humidity sensor, an atmospheric pressure sensor, a smell sensor, and/or any other sensors that can measure a current condition at the user device 200.

The user device 200 includes a processor 208, memory 210, wireless transceiver 212, and input/output 214. The processor 208 controls operation of the sensors 202, 204, and 206, the memory 210, the wireless transceiver 212, and the input/output 214. The environmental variables sensed by the sensors 202, 204, and 206 can be stored in the memory 210. Via the wireless transceiver 212, the user device 200 can communicate with other devices, service providers, the Internet, etc. For example, the user device can receive streaming content via the wireless transceiver 212. The input/output 114 allows for user interaction with the user device 100. For example, the input/output 114 can include, but is not limited to, a display, touch screen, keyboard, mouse, speakers, buttons, etc.

A content database 216 is stored in the memory 210 of the user device 200. The content database 216 includes pre-stored content that is associated with various environmental states. According to one embodiment, the content database 216 can store advertising content that is associated with various environmental states. When the environmental variables are received from the sensors 202, 204, and 206, the processor 208 deduces at least one environmental state based on the environmental variables and selects content in the content database 216 to match the deduced environmental state. The processor 208 then controls the input/output 214 to output the selected content that matches the current environmental state(s). For example, the content can be displayed on a display and/or played through speakers of the user device 100. If the content is advertising content, the processor 208 can control the selected content to be output so predetermined portions of streaming video or music are streamed to the user device 200. In addition, the environment could be used to dynamically modify the content. For example, if the weather is hot, then the background of the ad could be changed to be a winter scene, while the main part of the ad is unchanged. Other parts of the ad could be changed to reflect the overall environment. These changes could be applied locally or could be done remotely from a server.

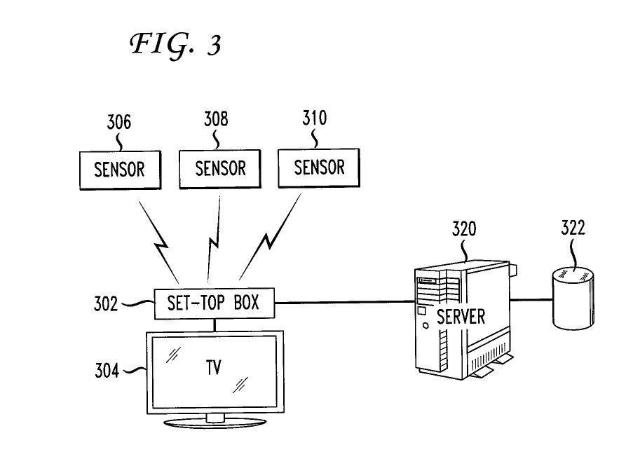

In FIGS. 1 and 2, content is selected based on environmental variables selected at a mobile user device. However, the present disclosure is not limited to a mobile user device. FIG. 3 illustrates an exemplary system configured to implement another embodiment of the present disclosure. As illustrated in FIG. 3, a set top box 302 is connected to a television 304. For example, the set top box 302 can be a digital cable receiver, a satellite television receiver, or in IPTV receiver. The set top box 302 is connected to a server 320, which provides television content to the set top box 302. The set top box 302 controls the television content that is displayed on the television 304.

As illustrated in FIG. 3, sensors 306, 308, and 310 communicate with the set top box 302. The sensors 306, 308, and 310 sense various environmental variables in the vicinity of the set top box 302. According to an advantageous implementation, the sensors 306, 308, and 310 may include one or more of a noise or volume sensor, a temperature sensor, a humidity sensor, an atmospheric pressure sensor, a smell sensor, and/or any other sensors that can measure a current condition in the vicinity of the set top box 302. In a possible implementation, the sensors 306, 308, and 310 can be located in the vicinity of the set top box 302 in various locations around a room in which the set top box 302 is located. Accordingly, the sensors 306, 308, and 310 sense environmental variables corresponding the environment in which a user is watching television. In one implementation, the sensors 306, 308, and 310 can communicate with the set top box 302 wirelessly through a predetermined protocol, such as Bluetooth.

The environmental variables sensed by the sensors 306, 308, and 310 are received by the set top box 302, and transmitted from the set top box 302 to the server 320. The server 320 deduces at least one environmental state based on the environmental variables and selects content in a content database 322 to match the deduced environmental state. The content database 322 can be located locally to the server 320 or remotely from the server 320. The selected content that matches the deduced environmental state(s) is then added to the television content being transmitted to the set to box 302. For example, if the content is advertising content, the streaming server can stream advertisements selected to match the current environmental state in the vicinity of the set top box 302, in addition to the television content being delivered to the set top box 302 to be displayed on the television 304. The content selected to match the current environmental state is received at the set top box 302 and output to the television 304.

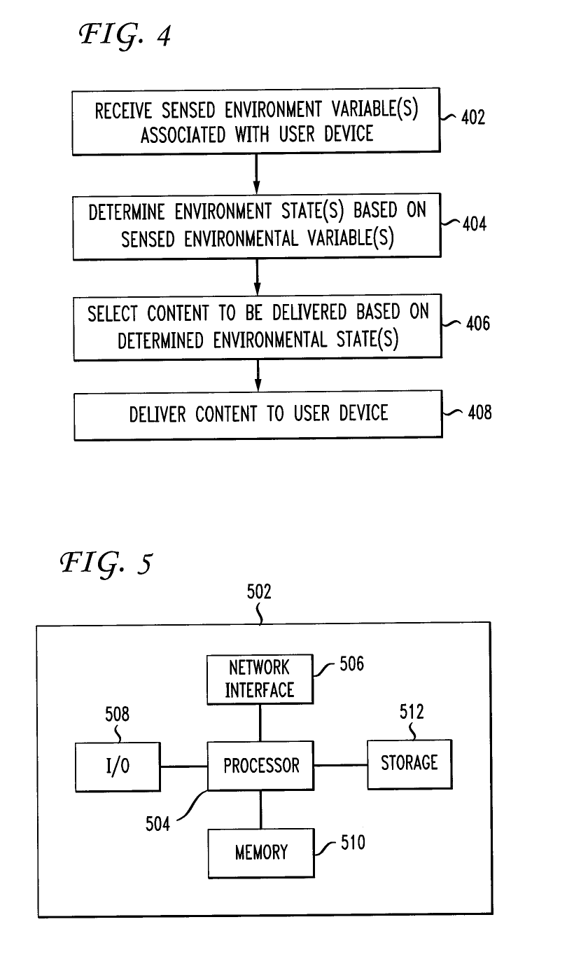

FIG. 4 illustrates a method for targeted content delivery according to an embodiment of the present disclosure. At step 402, at least one sensed environmental variable associated with a user device is received. The user device may be a mobile device. According to one possible implementation, at least one environmental variable can be sensed by at least one sensor at the user device. For example, the sensors illustrated in FIGS. 1 and 2 are located at the user devices. According to another possible implementation, at least one environmental variable can be sensed by at least one sensor in the vicinity of the user device and in communication with the user device. For example, the sensors illustrated in FIG. 3 are located in the vicinity of the user device. Sensors for sensing the environmental variables can include a noise or volume sensor, a temperature sensor, a humidity sensor, an atmospheric pressure sensor, a smell sensor, and/or any other sensors that can measure a current condition at or in the vicinity of the user device. Other examples of environmental variables that can be sensed are personal environmental variables associated with a user of the user device.

For example, sensors for sensing personal information of the users, such as heart rate, body temperature, blood sugar level, etc., can communicate with a user device and send the sensed, personal environmental data of the user to the user device. Such sensors can include implantable sensors that can be implanted under a user's skin or wearable sensors, such as a heart monitor, watch, etc., that communicate with a user device. It is also possible to sense current media being output by the user device or in the vicinity of the user device, as well as sensing voices on the user device or in the vicinity of the user device.

Returning to FIG. 4, at step 404 at least one environmental state is determined based on the sensed at least one environmental variable. In order to determine the environmental state based on one or more environmental variables, the variables are first categorized into discrete levels. This can result in the determined environmental state. It is also possible that further inference and deduction can be performed using the categorized environmental variables and additional information.

In order to categorize the environmental variables, stored thresholds for each variable can be used to determine a current state for each variable. For example, if the temperature at the user device is sensed, various temperature ranges can correspond to various temperature categories, such as “very hot”, “hot”, “warm”, “average”, “cool”, “cold”, and “very cold”. Similarly, humidity categories, such as “very humid”, “humid”, “average”, “dry”, and “very dry”, can be defined. It is to be understood that these categories and variables are merely exemplary, and do not limit the general inventive concept.

It is also possible that trained classifiers can be used to categorize received environmental variables. For example, a sound can be detected, and a trained sound classifier can determine that the sound is “music”, “voice”, or “crowd noise”. If the sound is detected as “music”, another trained classifier may be able to recognize a type of music, such as “classical”, “jazz”, “rock”, “country”, etc., or the specific artist or composer. If the sound is detected as “voice”, a trained classifier may be able to recognize who the user is speaking to or what the user is saying. It is to be understood that these categories, variables, and classifiers are merely exemplary, and do not limit the general inventive concept.

Once the environmental data is categorized, the information collected or determined may be enough to determine the environmental state. For example, based on temperature and humidity data, it could be determined that the environment surrounding the user device is hot and humid. Based on detected sounds, it could be determined that the user of the user device is listening to classical music. However, it is also possible that further inference and deduction can be performed using the categorized environmental variables and additional information. In one embodiment, location data received from the user device can be used together with the environmental variables to determine an environmental state. In another embodiment, a network, such as the Internet, can be used to deduce additional information that can be used together with the environmental variables to determine the environmental state. For example, if a detected sound is determined to be “crowd noise”, GPS information can give a location of the user device. Based on the location of the user device, an Internet search can be performed based on the location. Because it has been determined that the user device is surrounded by crowd noise it can be deduced that the user is at sporting event discovered by the Internet search.

Returning to FIG. 4, at step 406, content is selected to be delivered to the user device by matching content to the determined at least one environmental state. The content can be stored and categorized based on various environmental states. The selection of content to be delivered to the user device based on the detected environmental states targets users based on environmental conditions at the user device. According to an advantageous implementation, the content can be advertising content. For example, if an environmental state of hot and humid is determined, content advertising cold drinks or air conditioning can be selected. In addition, the environmental state can be combined with GPS information to optimize an ad. If in addition to hot and humid conditions, there is a nearby ice cream parlor, then that situation could generate an ad for the local ice cream parlor. If it is determined that the user is listening to classical music, an advertisement for the symphony may be selected. If it is determined that the user has elevated stress levels, an advertisement for a vacation may be selected. If it is determined that a user is at a certain sporting event, an advertisement related to that sport may be selected. It is to be understood that these examples are not intended to limit the general inventive concept.

Furthermore, the present disclosure is not limited to advertising content, and the content may also be various other types of content, including but not limited to streaming media (video, music, etc.), pre-stored personalized content, suggested media or activities, predictive information based on the current environmental state, etc. For example, if the determined environmental state indicates that the user is listening to a certain artist or type of music, suggestions for other similar artists may be selected. If it is determined that a user has elevated stress levels, relaxing music or a comedy video may be selected to be delivered to the user device. If it is determined that a user is talking to a certain person, a pre-store personalized message regarding that person may be delivered to the user device. It is to be understood that these examples are not intended to limit the general inventive concept.

Returning to FIG. 4, at step 408, the selected content is delivered to the user device. For example, the selected content can be streamed to the user device from a server. If the selected content is advertising content, the advertising content can be delivered with other streaming content from a server. The content may also be delivered to the user device, by a processor of the user device controlling a display and/or speakers of the user device to output the content.

FIG. 4 illustrates a method for delivering targeted content based on sensed environmental data. The method of FIG. 4 can be repeated to continually update the content being selected for a user device. In one embodiment, user input is received at the user device and transmitted with the sensed environmental variables. The user input can give an indication of the relevance of the targeted content. The user input can be intentionally entered by the user, for example, using an input of the user device (e.g., keyboard, buttons, voice command, etc.). It is also possible that the user input can be derived from the user's involuntary reactions in the form of personalized environmental variables, such as heart rate. The user input is used along with the sensed environmental variables to deduce a current environmental state and select additional content to be delivered.

The method of FIG. 4 may be implemented on a computer using well known computer processors, memory units, storage devices, computer software, and other components. In particular, the user devices, servers, and set top box illustrated in FIGS. 1-3 can be implemented as such a computer. A high level block diagram of such a computer is illustrated in FIG. 5. Computer 502 contains a processor 504 which controls the overall operation of the computer 502 by executing computer program instructions which define such operation. The computer program instructions may be stored in a storage device 512 (e.g., magnetic disk) and loaded into memory 510 when execution of the computer program instructions is desired. Thus, the method of FIG. 4 can be implemented by the processor 504 executing computer program instructions stored in the memory 510, storage 512, and or other computer readable storage medium. The computer 502 also includes one or more network interfaces 506 for communicating with other devices via a network. The computer 502 also includes input/output interfaces 508 which represent devices which allow for user interaction with the computer 502 (e.g., display, keyboard, mouse, speakers, buttons, etc.) One skilled in the art will recognize that an implementation of an actual computer will contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for targeted content delivery comprising:
receiving at least one sensed environmental variable associated with a user device;
determining at least one environmental state based on the at least one environmental variable;
selecting content to be delivered to the user device based on the at least one environmental state; and
delivering the selected content to the user device.

2. The method of claim 1, wherein said step of receiving at least one environmental variable associated with a user device comprises:
receiving at least one environmental variable sensed at the user device.

3. The method of claim 1, wherein said step of receiving at least one environmental variable associated with a user device comprises:
receiving at least one environmental variable sensed in a vicinity of the user device by a sensor in communication with the user device.

4. The method of claim 1, wherein:
said step of receiving at least one sensed environmental variable associated with a user device comprises receiving said at least one sensed environmental variable at a server from the user device;
said steps of determining at least one environmental state and selecting content to be delivered are performed at the server; and
said step of delivering the selected content to the user device comprises delivering the selected content to the user device from the server.

5. The method of claim 1, wherein
said step of receiving at least one sensed environmental variable associated with a user device comprises receiving said at least one sensed environmental variable at the user device from at least one sensor;
said steps of determining at least one environmental state and selecting content to be delivered are performed at the user device; and
said step of delivering the selected content to the user device comprises controlling an output of the user device to output the selected content.

6. The method of claim 1, wherein said step of determining at least one environmental state based on the at least one environmental variable comprises:
categorizing the at least one environmental variable into one of a plurality of predetermined levels.

7. The method of claim 6, wherein said step of determining at least one environmental state based on the at least one environmental variable further comprises:
deducing the at least one environmental state based on the categorized level of the at least one environmental variable and information from at least one other information source.

8. The method of claim 7, wherein the information from at least one other information source comprises at least one of location information, Internet information, and user input.

9. The method of claim 1, wherein said step of selecting content to be delivered to the user device based on the at least one environmental state comprises:
matching content stored in a content database to the determined at least one environmental state.

10. The method of claim 1, wherein said step of delivering the selected content to the user device comprises:
streaming the selected content to the user device.

11. The method of claim 1, wherein the selected content is advertising content.

12. The method of claim 1, further comprising:
receiving user feed back regarding the selected content; and
selecting additional content to be delivered to the user device based at least in part on the received user feedback.

13. An apparatus, comprising:
means for receiving at least one sensed environmental variable associated with a user device;
means for determining at least one environmental state based on the at least one environmental variable;
means for selecting content to be delivered to the user device based on the at least one environmental state; and
means for delivering the selected content to the user device

14. The apparatus of claim 13, wherein said means for determining at least one environmental state based on the at least one environmental variable comprises:
means for categorizing the at least one environmental variable into one of a plurality of predetermined levels.

15. The apparatus of claim 14, wherein said means for determining at least one environmental state based on the at least one environmental variable further comprises:
means for deducing the at least one environmental state based on the categorized level of the at least one environmental variable and information from at least one other information source.

16. The apparatus of claim 13, wherein said means for selecting content to be delivered to the user device based on the at least one environmental state comprises:
means for matching content stored in a content database to the determined at least one environmental state.

17. A computer readable medium encoded with computer executable instructions for targeted content delivery, said computer executable instructions defining steps comprising:
receiving at least one sensed environmental variable associated with a user device;
determining at least one environmental state based on the at least one environmental variable;
selecting content to be delivered to the user device based on the at least one environmental state; and
delivering the selected content to the user device.

18. The computer readable medium of claim 17, wherein the computer executable instructions defining the step of determining at least one environmental state based on the at least one environmental variable comprise computer executable instructions defining the step of:
categorizing the at least one environmental variable into one of a plurality of predetermined levels.

19. The apparatus of claim 18, the computer executable instructions defining the step of determining at least one environmental state based on the at least one environmental variable further comprise computer executable instructions defining the step of:
deducing the at least one environmental state based on the categorized level of the at least one environmental variable and information from at least one other information source.

20. The apparatus of claim 17, wherein the computer executable instructions defining the step of selecting content to be delivered to the user device based on the at least one environmental state comprise computer executable instructions defining the step of:
matching content stored in a content database to the determined at least one environmental state.
